(19) United States
(12) Patent Application Publication
(10) Pub. No.: US 2014/0042242 A1
(43) Pub. Date: Feb. 13, 2014

(54) QUICK-DISCONNECT KEYED VENTURI

(71) Applicant: Hydra-Flex, Inc., Burnsville, MN (US)

(72) Inventors: Karl J. Fritze, Hastings, MN (US); Zachary Cornett, Lakeville, MN (US)

(21) Appl. No.: 13/957,047

(22) Filed: Aug. 1, 2013

Related U.S. Application Data
(60) Provisional application No. 61/678,430, filed on Aug. 1, 2012.

(51) Int. Cl. B05B 9/03

(52) U.S. Cl. CPC B05B 9/035
USPC 239/95

(57) ABSTRACT

A chemical delivery system and related methods of use in which a multi-port manifold is utilized to distribute a plurality of mixed chemical solutions. The multi-port manifold includes a single fluid inlet for receiving a diluent supply that is routed to a plurality of individual outlet ports. A venturi injector module including a valve assembly, a venturi mixing assembly and a latch assembly is fluidly coupled to each outlet port for individually controlling flow of the diluent through the outlet port. The venturi mixing assembly generally comprises a quick-connect projection for coupling the venturi mixing assembly to the outlet port. The latch assembly functions to retain the fluid connection of the venturi mixing assembly and the outlet port. The latch assembly and venturi mixing assembly generally include corresponding portions of a keyway shape that ensures that only the proper venturi mixing assembly is attached to the proper outlet port.

### RELATED APPLICATION

The present application claims the benefit of U.S. Provisional Application No. 61/678,430 filed Aug. 1, 2012, and entitled “QUICK-DISCONNECT KEYED VENTURI”, which is incorporated herein in its entirety by reference.

### FIELD OF THE INVENTION

The present disclosure relates to the field of chemical dilution and dispensing. In particular, the present disclosure is directed to a chemical delivery system that effectively and uniformly mixes concentrated liquid chemicals with a liquid diluent using quick-connect keyed venturi eductors allowing for easy eductor connection while increasing safety through the prevention of cross-contamination.

### BACKGROUND OF THE INVENTION

Chemical mixing and distribution system are frequently used in the spraying of chemicals for cleaning, fertilizing, application of pesticides, rinsing, and chemical application. One advantage of these mixing and distribution system is that concentrated chemicals cost less to store and transport than fully diluted chemicals. In applications where fully concentrated chemical are to be diluted, venturi eductor systems can be used to dilute the concentrated chemical into its correct concentration for subsequent application. Venturi eductors perform this job very well and can be very accurate in their dilution ratios. Generally, these venturi educator are coupled to distribution manifolds and supply lines using conventional coupling mechanisms.

A wide variety of coupler designs are used to connect and disconnect tubes, pipe, and conduit. For instance, threaded pipe and barbed fittings are very commonly used methods of connect tubing and pipes but may prove difficult to install and in some cases, may not be removed without destroying the pipe or tube in the process. In addition to traditional threaded and barbed connections, a variety of push-to-connect or quick-connect fitting have been designed to facilitate installation, removal and replacement of fluid components. For example, U.S. Pat. Nos. 4,436,125, 4,588,214, 5,052,725, which are hereby incorporated by reference in their entirety, all teach various mechanisms to simplify the connection and disconnection of fluid circuits.

While currently available coupler designs allow for the quick assembly, disassembly, repair and replacement of chemical delivery systems and their components, it would be beneficial to provide additional safety features to ensure that the proper components are utilized in the proper fluid circuit. More specifically, it would be advantageous to utilize venturi injectors that have the benefit of quick-connect style connections while verifying that they are being used in the correct fluid circuit.

### SUMMARY OF THE INVENTION

The present application is generally directed to a chemical delivery system in which a multi-port manifold is utilized to distribute a plurality of mixed chemical solutions to various points of use. Generally, the multi-port manifold includes a single fluid inlet for receiving a diluents supply, such as, for example, a water supply. The diluents supply is routed through a shared diluent supply line within the multi-port manifold to a plurality of individual outlet ports. A venturi injector module including a valve assembly, a venturi mixing assembly and a latch assembly is fluidly coupled to each outlet port for individually controlling flow of the diluent through the outlet port. The venturi mixing assembly generally comprises a quick-connect projection for coupling the venturi mixing assembly to the outlet port. The latch assembly functions to retain the fluid connection of the venturi mixing assembly and the outlet port. The latch assembly and venturi mixing assembly generally include corresponding portions of a keyway shape that ensures that only the proper venturi mixing assembly is attached to the proper outlet port. In this manner, venturi mixing assemblies having venturi properties directed to specific chemicals or applications are not inadvertently attached to outlet ports on the multi-port manifold that intended for use with different chemicals or applications.

In one representative embodiment, the present application is directed to a multi-port manifold having a single diluent inlet port, a diluent supply line and a plurality of outlet ports. Each outlet port is fluidly connected to a venturi injector module using a quick-connect style connection. The quick-connect style connection can include a projecting nose portion on the venturi injector module that is inserted into the corresponding outlet port. A latch assembly including a latch body and a latch can receive the projecting nose portion and can fixedly retain fluid connection of the venturi injector module and the multi-port manifold. Each venturi injector module can further comprise a valve assembly for selectively opening and closing whereby a diluent is supplied to the venturi injector module such that a concentrated chemical can be educted and drawn into the diluent so as to created a chemical solution for delivery to a point of use.

In another representative embodiment, the present application is directed to a chemical delivery system comprising a multi-port manifold, a plurality of latch assemblies and a plurality of a venturi injectors. Each latch assembly can comprise a latch body and a latch, wherein the latch body is positioned adjacent a corresponding outlet port on the multi-port manifold. The venturi injector can be inserted through the corresponding latch body and outlet port wherein the latch slides through a slot in the latch body to retain the coupling of the venturi injector and the multi-port manifold. The latch and venturi injector can comprise a keyway arrangement whereby corresponding projections on the latch and venturi injector verify that only the correct venturi injector can be connected and retained by the matching latch. In some embodiments, two or more of the venturi injector, the latch assembly and the outlet port can comprise a similar color so as to provide a further visual indication that the correct venturi injector is being utilized with the corresponding outlet port on the multi-port manifold.

In yet another embodiment, the present application is directed to methods of delivering a plurality of educted chemical streams to various points of use. The method can comprise supplying a diluents stream to an inlet port on a multi-port manifold. The method can further comprise distributing the diluent stream through a plurality of outlet ports on the multi-port manifold. The method can further comprise attaching a keyed latch assembly to each outlet port wherein a latch includes various projections so as to only accommodate insertion of a venturi injector having matching projections. In some embodiments, the method can further comprise confirming attachment of the correct venturi injector to the correct outlet port by visually verifying a matching exterior color on two or more of the venturi injector, the latch assembly or the outlet port. The method can further comprise retaining connection of the venturi injector and the outlet port with the latch by slidably inserting the latch through a slot in a latch body.

In another representative embodiment, the chemical delivery system of the present application provides for a common diluent such as water, to be used to create multiple low-concentration chemical feeds. In various industries, it is desirable to use low-cost venturi eductors to provide specific dilution ratio circuits for a variety of chemicals. Each chemical is to be kept separate from and not be cross-contaminated with any other chemicals, yet provide fast, easy, and simple connection and removal. The chemical delivery system utilizes a plurality of venturi eductors that are adapted for use with a robust quick connect/disconnect coupler on outlet ports of a multi-port manifold. The venturi eductors are keyed in such a manner to allow its connection to the outlet port using a similarly keyed latch assembly. The chemical delivery system as taught herein is well suited for use in the food preparation and restaurant industry due to the ability to safely and reliably provide a variety of continuous streams of mixed chemical suited for sanitization and cleaning.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE FIGURES

The invention can be more completely understood in consideration of the following detailed description of various embodiments of the invention in connection with the accompanying drawings, in which:

FIG. 1 is an isometric view of a chemical delivery system having a multi-port manifold and a plurality of injector modules according to an embodiment of the present invention.

FIG. 2 is a top view of the chemical delivery system depicted in FIG. 1.

FIG. 3 is a side view of the chemical delivery system depicted in FIG. 1.

FIG. 4 is a top cross-sectional view of the chemical delivery system depicted in FIG. 1.

FIG. 5 is an end view of the chemical delivery system depicted in FIG. 1.

FIG. 6a is a side cross-sectional view of an injector module according to an embodiment of the present invention.

FIG. 6b is a partial side cross-sectional view of the injector module depicted in FIG. 6a.

FIG. 7a is a rear isometric view of a latch assembly according to an embodiment of the present invention.

FIG. 7b is a rear isometric view of the latch assembly depicted in FIG. 7a.

FIG. 8a is a side cross-sectional view of a latch assembly according to an embodiment of the present invention, wherein the latch is positioned in the disengaged position.

FIG. 8b is a front view of the latch assembly depicted in FIG. 8a.

FIG. 9a is a side cross-sectional view of a latch assembly according to an embodiment of the present invention, wherein the latch is positioned in the disengaged position.

FIG. 9b is a front view of the latch assembly depicted in FIG. 9a.

FIG. 10 is an isometric view of a mixing assembly of an injector module according to an embodiment of the present invention.

FIG. 11 is an exploded isometric view of a mixing assembly of an injector module according to an embodiment of the present invention.

FIG. 12a is a partial isometric view of a mixing assembly of an injector module according to an embodiment of the present invention.

FIG. 12b is a partial isometric view of a latch assembly according to an embodiment of the present invention.

FIG. 13a is a representative view of a keyway defined by a latch assembly and a correspondingly shaped nose portion of a mixing assembly according to an embodiment of the present invention.

FIG. 13b is a representative view of a keyway defined by a latch assembly and a correspondingly shaped nose portion of a mixing assembly according to an embodiment of the present invention.

FIG. 13c is a representative view of a keyway defined by a latch assembly and a correspondingly shaped nose portion of a mixing assembly according to an embodiment of the present invention.

FIG. 13d is a representative view of a keyway defined by a latch assembly and a correspondingly shaped nose portion of a mixing assembly according to an embodiment of the present invention.

FIG. 13e is a representative view of a keyway defined by a latch assembly and a correspondingly shaped nose portion of a mixing assembly according to an embodiment of the present invention.

FIG. 13f is a representative view of a keyway defined by a latch assembly and a correspondingly shaped nose portion of a mixing assembly according to an embodiment of the present invention.

FIG. 13g is a representative view of a keyway defined by a latch assembly and a correspondingly shaped nose portion of a mixing assembly according to an embodiment of the present invention.

FIG. 13h is a representative view of a keyway defined by a latch assembly and a correspondingly shaped nose portion of a mixing assembly according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

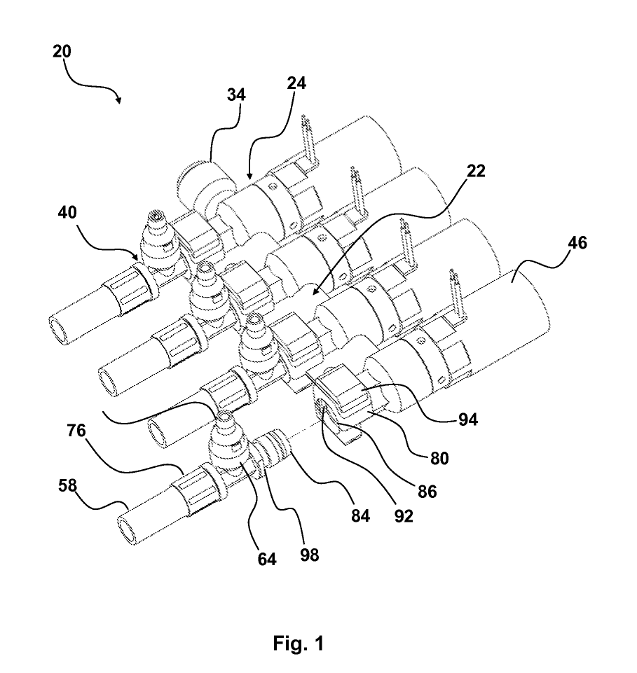

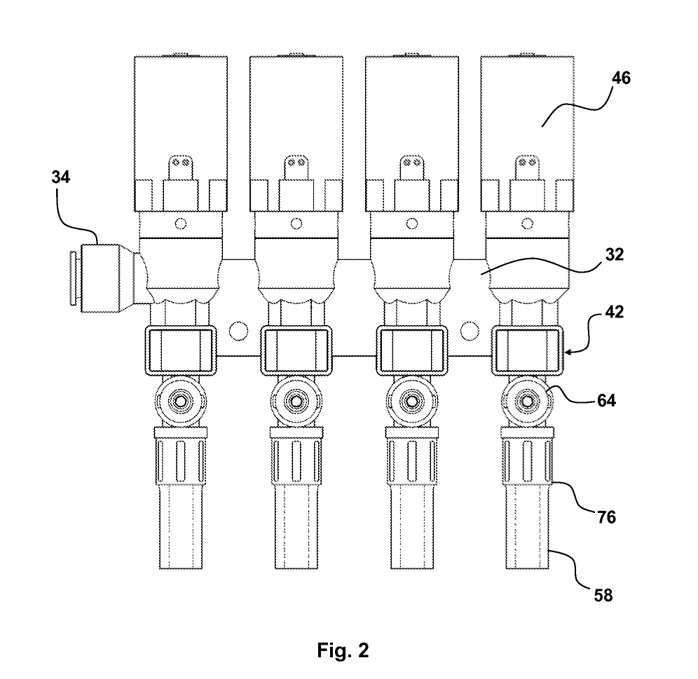

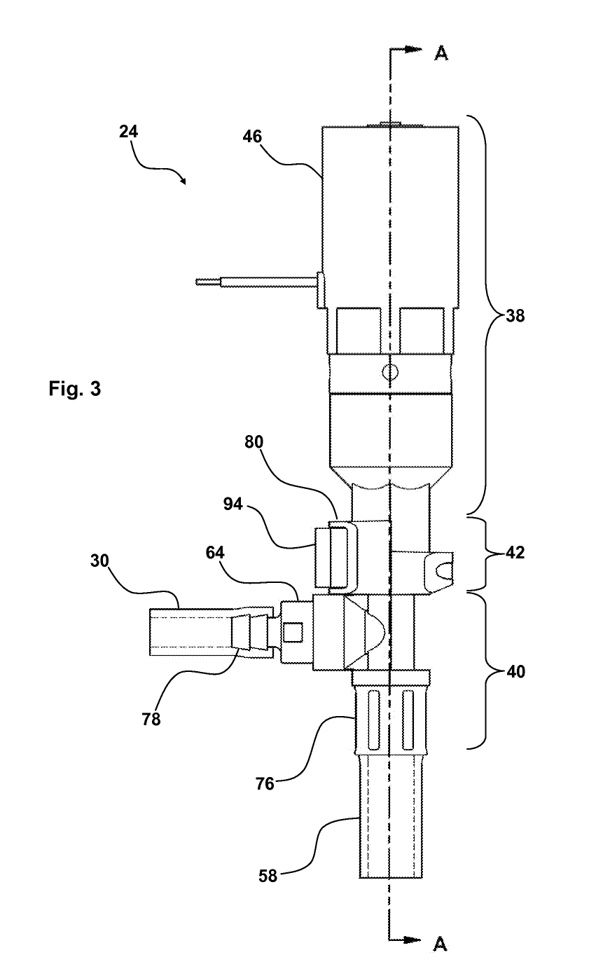

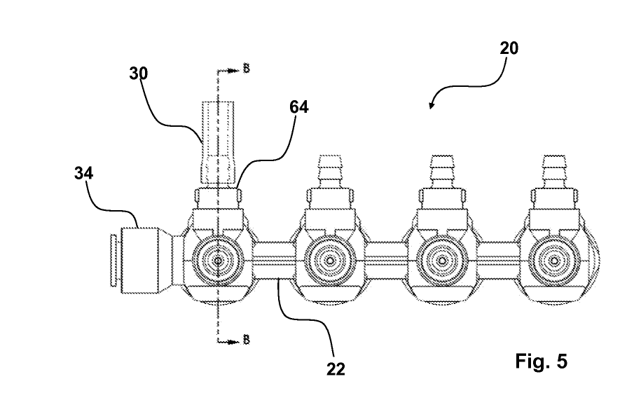

As depicted in FIGS. 1-5, a chemical delivery system 20, according to an embodiment of the present invention, comprises a multi-port manifold 22 and a plurality of injector modules 24. Generally, the multi-port manifold 22 defines a single diluent supply line 26 intersected by a plurality of secondary lines 28 defined by the plurality of the injector modules 24. A concentrate supply line 30 is fluidly connected to the secondary line 28 of each injector module 24, wherein each concentrate supply line 30 fluidly connects the secondary line 28 to a concentrate supply source. In operation, a diluent stream such as water or other diluting agent flows through the diluent supply line 26, wherein a portion of the diluent stream can be diverted into one or more of the secondary line 28. As the diluent stream passes through the secondary line 28, the diluent stream draws concentrate from the corresponding concentrate supply line 30 through a Venturi effect. The diluent stream and concentrate is then intermixed in the turbulent diluent stream to form a chemical solution stream. Each concentrate supply line 30 is linked to a different concentrate supply source such that each injector module 24 mixes a different chemical solution.

As depicted in FIGS. 1-5, the multi-port manifold 22 comprises an elongated manifold body 32, an inlet port 34 and a plurality of outlet ports 36. The elongated manifold body 32 defines the single diluent supply line 26, wherein the diluent stream enters through the inlet port 34 and exits through at least one of the outlet ports 36 and into one of the secondary lines 28. As depicted, the inlet port 34 comprises a push-to-connect fitting for linking the multi-port manifold 22 to tube or pipe fluidly connected to a diluent source. In certain embodiments, the inlet port 34 can comprise a male barbed tube ferrule or pipe threads.

In certain embodiments, the manifold body 32 can further comprise a secondary outlet port (not pictured) through which an excess portion or the entire diluent stream can exit the manifold body 22 without entering one of the secondary lines 26. In this configuration, the diluent stream is continuously flowed through the manifold body 32, wherein the unused diluent stream is recycled back to the inlet port 34 of the manifold body 32 or vented from the system 20.

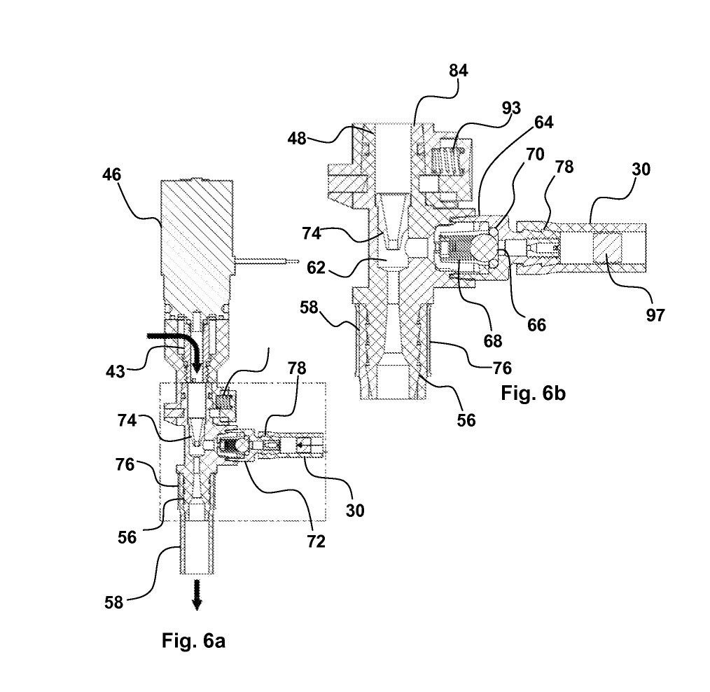

As depicted in FIGS. 1-5 and 6a-6b, an injector module 24, according to an embodiment of the present invention, comprises a valve assembly 38, a mixing assembly 40 and a latch assembly 42 for fluidly connecting the mixing assembly 40 to the valve assembly 38. The valve assembly 38 comprises a first conduit 43, a valve 44 and a valve actuator 46. The valve 44 is movable by the valve actuator 46 between a closed position in which the flow of diluent into the first conduit 43 is restricted and an open position in which in which the diluent can flow into the first conduit 43 unrestricted. The valve assembly 46 can be operated to position the valve 44 in the open or closed position in analog manner or in a pulsing manner to throttle the diluent flow rate as desired. As depicted, the valve 44 comprises a diaphragm valve, wherein the valve actuator 46 comprises a solenoid for actuating the diaphragm. In other embodiments, the valve 44 and valve actuator 46 can comprise other conventional valves including to, but not limited to gate valves, globe valves, needle valves and ball valves.

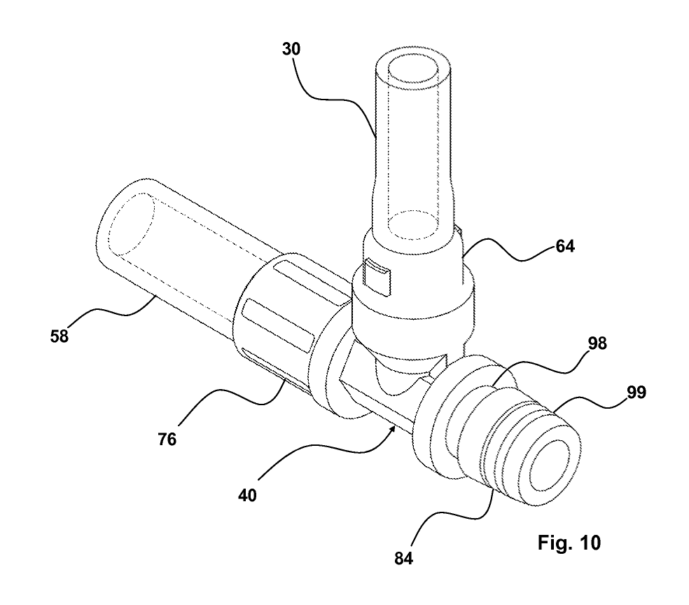

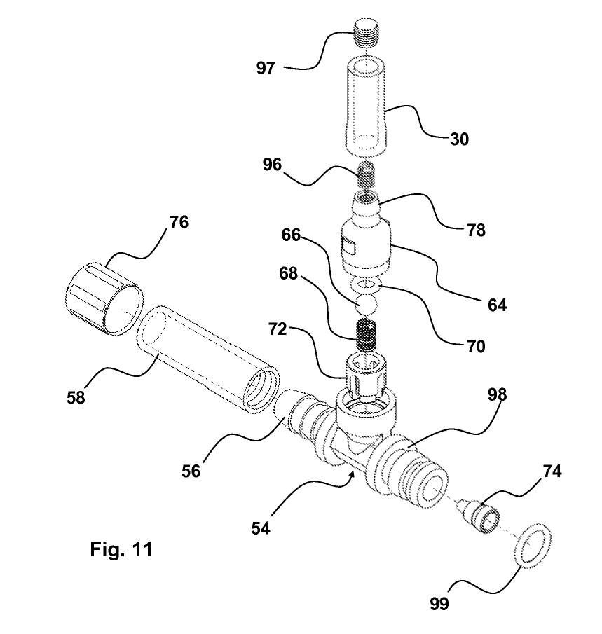

The mixing assembly 40 comprises a second conduit 48 and a concentrate line connector 50. The second conduit 48 comprises an inlet portion 50, an outlet portion 52 and mixing portion 54. The inlet portion 50 is fluidly connectable to the first conduit 43 of the valve assembly 38 such that the first fluid conduit 42 and second conduit 48 cooperatively define the secondary line 28. Similarly, the outlet portion 52 comprises a hose barb 56 insertable into an outlet tube 58 for receiving the mixed chemical solution stream, wherein the outlet tube 58 directs the mixed chemical solution into a container or is fluidly connected to system for applying the chemical solution including, but not limited to a sprayer or atomizer. In this configuration, the outlet tube 58 comprises a flexible tubing material including, but not limited to PVC. In certain embodiments, the hose barb 56 is capable of retaining the outlet tube 58 on the hose barb 56 when the mixed chemical solution stream has a pressure between 0 and 1 atm. As depicted in FIGS. 10-11, in certain embodiments, the outlet portion 52 can further comprise a locking sleeve 76 that slides over the portion of the outlet tube 58 fitted over the hose barb 56. The locking sleeve 76 is sized to prevent create a friction fit preventing removal of the hose barb 56 from the outlet tube 58. In certain embodiments, the locking sleeve 76 can comprise a malleable metal such as copper, steel, stainless steel, brass or can be pressed in place with a strong plastic sleeve such as nylon. The mixing portion 54 comprises a Venturi chamber 60, a passive valve 62 and a concentrate port 64 transversely intersecting the secondary line. The concentrate supply line 30 can be fluidly connected to the Venturi chamber 60 via the concentrate port 64 to provide a chemical concentrate into the Venturi chamber 60. In certain embodiments, the concentrate port 64 further comprises a hose barb 78 insertable into the concentrate supply line 30 to secure the concentrate supply line 30 to the concentrate port 64. The passive valve 62 comprises a ball 66, a spring 68, a gasket 70, and a housing 72. The ball 66, spring 68 and gasket 70 are positioned within the housing 72 axially such that the spring 68 biases the ball 66 against the gasket 70 to prevent the flow of concentrate between the gasket 70 and the ball 66.

In operation, the flow of diluent through the Venturi chamber 60 creates a vacuum overcoming the bias of the spring 68 separating the ball 66 from the gasket 70 and allowing concentrate to be drawn into the Venturi chamber 60 for intermixing with the diluent. In certain embodiments, the bias of the spring 68 can be varied to alter the flow rate of diluent necessary to overcome the spring bias, which correspondingly alters the resulting concentration of the chemical solution. Similarly, in certain embodiments, the mixing portion 54 further comprises a nozzle 74 for increasing the flow rate of the diluent and correspondingly the vacuum drawing the concentrate through the concentrate port 64. In this configuration, the nozzle 74 creates a forceful jet action and a nearly perfect vacuum in its corresponding vena contracta region, wherein the concentrate is drawn into the venturi to be diluted and mixed in a turbulent vortex. The nozzle 74 comprises a corrosion resistant metal including, but not limited to stainless steel, durable polymers and other materials capable of withstanding wear from particulates within the diluent stream.

In certain embodiments, the concentrate port 64 can further comprise a restrictor element 96 that slows flow of concentrate through the concentrate port 64. The restrictor element 96 can comprise a helical cut or porous material to create a torturous path through the restrictor element 96, a small diameter orifice to otherwise restrict the flow of concentrate through the concentrate port 64. In certain embodiments, the restrictor element 96 can be adjustable to alter the flow rate of concentrate through the concentrate port 64. In this configuration, the restrictor element 96 can also be adjusted by an external means such as a needle valve with a knob or screw or a valve that is controlled by an external signal such as pneumatic, hydraulic, or electrical control signal. In certain embodiments, the restrictor element 96 is fixed within the concentrate port 64. In other embodiments, the restrictor element 96 is removable form the concentrate port 64 whereby it can be replaced with another restrictor element 96 having different orifice/flow characteristics. In another embodiment, a restrictor element 97 can be positioned directly within the concentrate line 30.

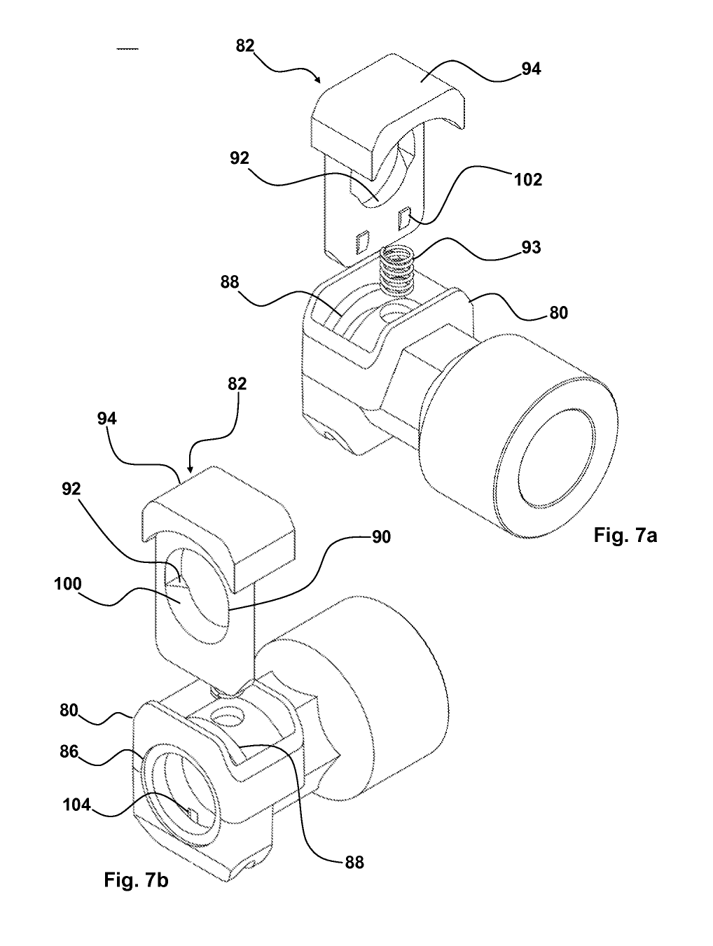

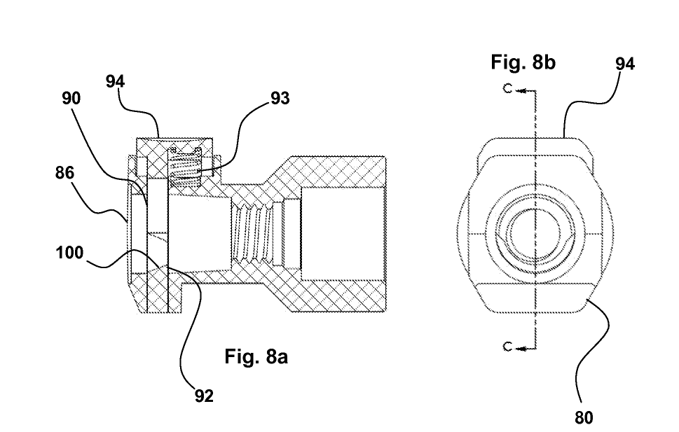

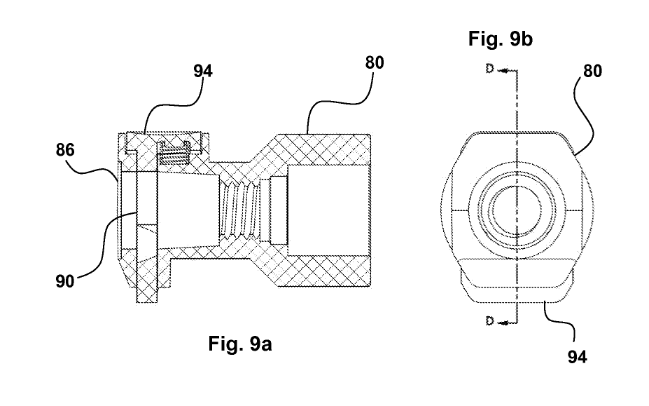

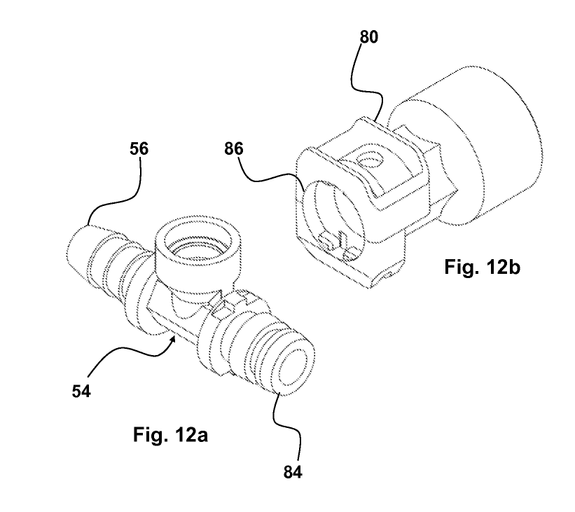

As depicted in FIGS. 7-9 and 12, a latch assembly 42 comprises a latch housing 80, a latch 82 and a corresponding nose portion 84. The latch housing 80 defines a port opening 86 and a slot 88 parallel to the plane of the port opening 86. The latch 82 defines an engagement opening 90 and a spring 93. The latch 82 is movable within the slot 88 between a disengaged position in which the engagement opening 90 is aligned with port opening 86 and an engaged position in which the engagement opening 90 is offset from the port opening 86, wherein the spring 93 biases the latch 82 into the engaged position. In certain embodiments, the nose portion 84 further comprises a locking groove 98 engagable by the latch 82 to prevent the nose portion 84 from being removed from the latch housing 80.

In certain embodiments, the latch 82 further comprises a button 94 that can be pressed to push the latch 82 into the disengaged position. The nose portion 84 is insertable into the portion opening 86 and the engagement opening 90 when the latch 82 is positioned in the disengaged position. As depicted in FIG. 11, the nose portion 84 comprises a sealing element 99 engagable by the latch 82 to prevent leakage of fluids between the latch 82 and the nose portion 84. In this configuration, the sealing element 99 can comprise an elastic sealing member shown as an o-ring, could be a lip seal, quad-ring, integral rib, or other feature designed to effect a fluid tight seal on the mating receiver port.

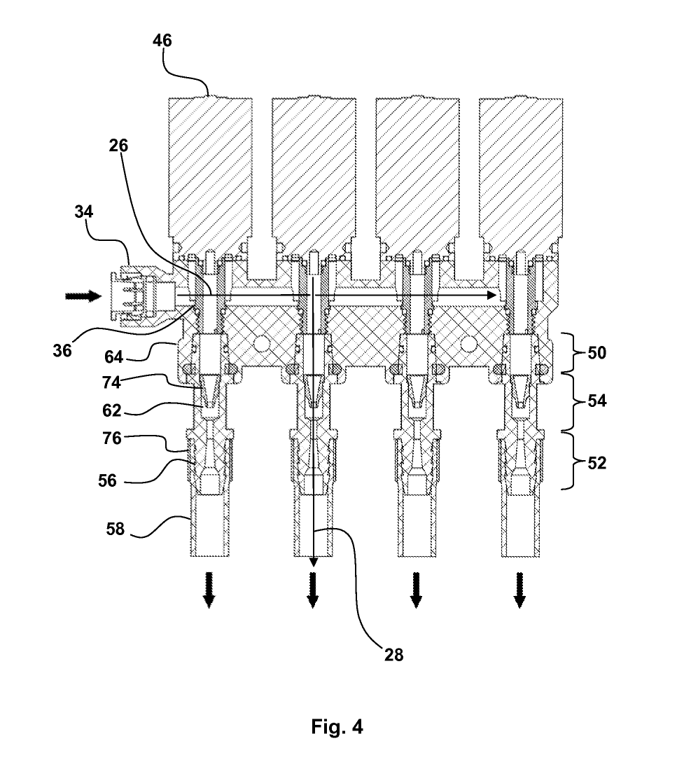

In certain embodiments, the nose portion 84 is tapered to relieve friction between the latch 82 and the nose portion 84 when the latch portion 82 is moved into the disengaged position. In certain embodiments, the outer diameter of the nose portion 84 closely approximates the inner diameter of the engagement opening 90 such that the nose portion 84 is only insertable when the engagement opening 90 is aligned with the port opening 86. When the latch 82 is biased back into the engaged position, the edges of the engagement opening 90 engage the nose portion 84 to retain the nose portion 84 within the latch housing 80. In certain embodiments, the latch 82 can further comprise a noise making feature that provides an auditory sound such as a click when the latch 82 is positioned in the engaged position. As depicted in FIG. 4, the latch housing 80 is affixed to or integrated into the manifold body 32, while the nose portion 84 is operably engaged to the second conduit 48 such that securing the nose portion 84 within the latch housing 80 secures the mixing assembly 40 to the valve assembly 38 and the multi-port manifold 22.

In certain embodiments, the latch 82 further comprises retention features 102 that allow initial assembly of the latch 82 into the slot 88. These retention features 102 act like barbs which temporarily expand the slot 88 to allow passage of the retention features 102 to pass into the slot 88. Once the latch 82 is fully depressed into the slot 88, the slot 88 relaxes back to its normal size and the retention features 102 operate within a pair of corresponding notches or pockets 104 on the opposing side of the slot 88. These retention features 102 allow limited vertical motion of the latch 82 and maintain the latch 82 within the slot 88 against the biasing force of the spring 93. In certain embodiments, retention feature 102 can comprise barbs on the latch 82 and pockets on the latch housing 80, or oppositely, barbs on the latch housing 80 and pockets in the latch 82. Further, the location of the retention features 102 can be most anywhere on the surfaces of these parts where it is convenient to tool for molding or the like of the features 102.

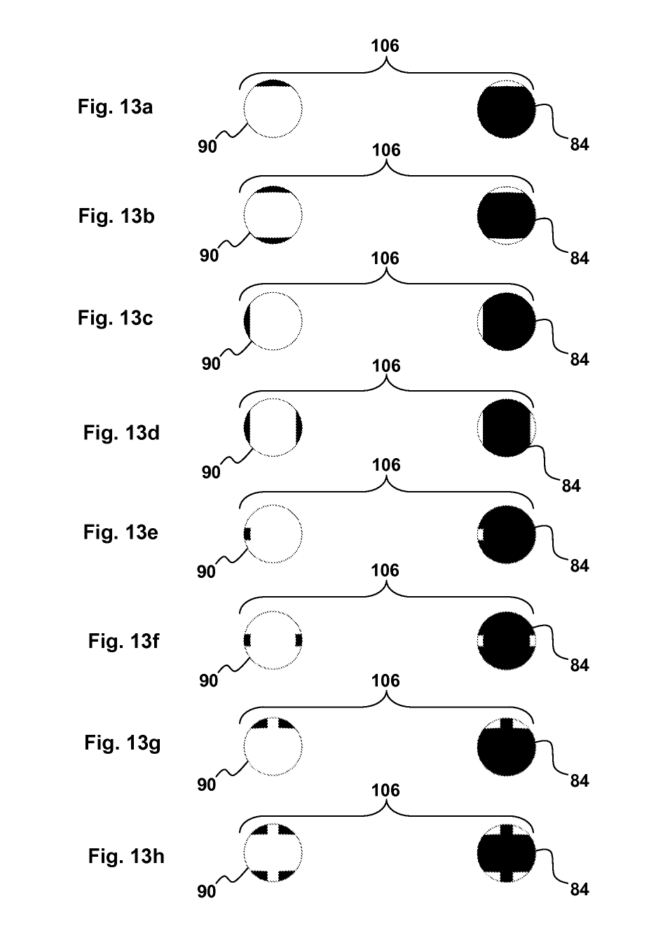

As depicted in FIGS. 7-9 and 19, the latch 82 further comprises at least one locking protrusion 92 extending radially inward into the engagement opening 90 such that the engagement opening 90 defines a unique keyway 106. As depicted in FIG. 13, the number and shape of the locking protrusions 92 can be varied to provide a plurality of unique keyway 106. Similarly, the corresponding nose portion 84 further comprises at least one corresponding protrusion 94 extending radially outward. The protrusions 94 are positioned to align congruently to the locking protrusions 92 such that only a nose portion 84 having the protrusions 94 corresponding to the unique keyway 106 defined by the engagement opening 90 is insertable through the engagement opening 90 and locked within the latch housing 80. In this configuration, each of latch 82 can comprise a unique keyway 106 accessible only by the corresponding nose portion 84 thereby preventing the incorrect mixing assembly 40, and correspondingly the attached concentrate line 30, from being attached to the wrong valve assembly 38. Each latch 82 can comprise a polymer such as ABS, PP, Nylon, PE, PPO, PS, Acetal and other polymers that are capable of withstand incidental chemical contact, ease of molding, strength, and dimensional and thermal stability.

In certain embodiments, the latch 82 can further comprise a keyed-feature insert defining the engagement opening 90 and comprising the corresponding locking protrusions 92. In this configuration, the keyed feature insert is fitted to each latch 82 allowing customized placement of each unique keyway 106.

As depicted in FIGS. 13A to FIG. 13H, the locking protrusions 92 can be arranged and sized to provide a plurality of different keyway 106 shapes. As depicted in FIGS. 13A and 13B, in certain embodiments, the locking protrusions 92 can comprise a linear edge commonly known as a d-shape or double d. Similarly, in other embodiments, the position of the locking protrusions 92 can be positioned at an offset position from other locking protrusions 92 to reduce the overall number of keyway 106 shapes while still preventing accidental engagement of the incorrect mixing assembly 40. In other embodiments, the locking protrusions 92 can comprise splines or flats of varying widths and radial position as depicted in FIGS. 13G and 13F. Similarly, the relative diameter of the protrusions 92 can be varied to provide another variable for providing a unique keyway 106. Also, the edges of the protrusions 92 can be curved as depicted in FIGS. 13E and 13F or otherwise shaped to create another level of keyway 106 uniqueness.

In certain embodiments, the latch 82 can be optionally colored to provide increased ease of identification. In this configuration, the choice of color for the latch 82 can be associated with the color indicator of the mixing assembly 40 or other identifying indicator to further assist the alignment of the correct mixing assembly 40 with the appropriate valve assembly 38.

As depicted in FIGS. 4, 6 and 10-11, during assembly, a valve assembly 38 of one of the injector module 24 is positioned within each outlet port 36 of the multi-port manifold 22 such that the first conduit 43 defines path by which the diluent can flow out of the multi-port manifold 22 through that outlet port 36. The corresponding valve assembly 38 operates the valve 44 to selectively permit or restrict the flow diluent through the first conduit 43. A concentrate supply line 30 is attached to the hose barb 78 of one of the mixing assemblies 40. Similarly, an outlet tube 58 is fitted to the corresponding hose barb 56 of the outlet portion 52 for that mixing assembly 40. In certain embodiments, a locking sleeve 56 is fitted over the overlapping portion of the outlet tube 58 and the hose barb 78 to secure the outlet tube 58 to the hose barb 56. The nose portion 84 of the mixing assembly 40 is then inserted into the latch housing 80 of the appropriate valve assembly 38 such that the first conduit 43 and second conduit 48 define the secondary line 28. In certain embodiments, the locking protrusions 92 comprise a sloped surface 100 allowing the insertion of the nose portion 84 to move the latch 82 into the disengaged position before the spring 93 returns the latch 82 to the engaged position when the nose portion 84 is fully inserted into the latch assembly 80. The unique keyway 106 of the latch 82 only permits the mixing assembly 40 to be fitted to the correct valve assembly 38. A mechanical or digital controller (not shown) controls the operation of the plurality of injector module 24 to selectively operate the appropriate valve assembly 38 to provide the desired chemical solution. The keying function of the latch assembly 42 ensures that each mixing assembly 40 and the corresponding concentrate supply line 30 are attached to the appropriate valve assembly 38 to avoid the incorrect chemical solutions from being formed when the controller is operated. In certain embodiments, the valve assembly 38 further comprises a check valve (not shown) that operates to prevent leakage of diluent when the mixing assembly 40 is not affixed to the valve assembly 38.

In operation, the selected valve assembly 38 is operated to permit the diluent stream to enter the secondary line 28 defined by the valve assembly 38 and the mixing assembly 40 of the injector module 24. In certain embodiments, the diluent stream is pressurized within the manifold body 32 such that operating one of the injector modules 24 causes diluent to flow from the manifold body 32 at a predetermined flow rate. In certain embodiments, the diluent stream can be pressurized within a range between about 30 psi to about 120 psi. In certain embodiments, the multi-port manifold 22 comprises materials capable of withstanding a pressurized diluent stream including pressures of about 60 psi to pressures of about 3000 psi. In certain embodiments, the multi-port manifold 22 can further comprise a secondary outlet port (not pictured) through which diluent stream not diverted through the at least one of the plurality of outlet ports 36 can be vented from the multi-port manifold 22. In this configuration, the diluent stream is continuously flowed through the multi-port manifold 22, wherein the portion of the diluent stream exiting through the secondary outlet port is recycled or discarded. The concentrate supply line 30 intersects each secondary line 28 transversely such that the flow of diluent through the secondary line 28 draws concentrate from the concentrate supply line 30 through the Venturi effect to intermix with the diluent passing through the secondary line 28 to form a chemical solution stream. In certain embodiments, each injector module 24 can comprise a concentrate supply line 30 having a different concentrate such that a plurality of different chemical solution streams can be mixed when each valve assembly 38 or combinations of valve assemblies 38 is operated.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A venturi injector system, comprising:
a multi-port manifold including an inlet port, a diluent supply line and a plurality of outlet ports, wherein a diluent stream enters the inlet port and is individually distributed to each outlet port through the diluent supply line; and
a plurality of venturi injector modules wherein each venturi injector module is individually attached to a corresponding outlet port, each injector module including a valve assembly, a venturi mixing assembly and a latch assembly, wherein the latch assembly operably couples the valve assembly and the venturi mixing assembly and wherein the latch assembly further includes a latch body having an engagement opening, wherein said engagement opening includes at least one locking protrusion defining a keyway shape corresponding to the venturi mixing assembly.

2. The venturi injector system of claim 1, wherein the latch assembly further comprises a latch, said latch being slidably positioned in a slot defined within the latch body, and wherein the at least one locking protrusion is located on the latch.

3. The venturi injector system of claim 2, wherein the venturi mixing assembly includes a nose portion being insertable through a port opening in the latch body such that the nose portion is sealing engaged within the corresponding outlet port.

4. The venturi injector system of claim 3, wherein the nose portion includes a nose protrusion, wherein the nose protrusion defines the keyway shape corresponding to the at least one locking protrusion on the latch.

5. The venturi injector system of claim 4, wherein the nose portion includes a sealing element, wherein the latch engages the sealing element to prevent fluid leakage between the latch and the nose portion.

6. The venturi injector system of claim 4, wherein the latch assembly comprises a first color and wherein the corresponding venturi mixing assembly also comprises the first color so as to indicate that the venturi mixing assembly is attachable to the latch assembly.

7. The venturi injector system of claim 4, wherein a second latch can replace the latch and wherein the second latch has at least one locking protrusion arranged differently on the latch so as to define a second keyway shape and wherein a second venturi mixing assembly can replace the venturi mixing assembly, the second venturi mixing assembly having a second nose protrusion corresponding to the second keyway shape.

8. The venturi injector system of claim 4, wherein the latch includes a pair of retention members, said retention members inserting into a corresponding pair of pockets on the latch body to retain the latch within the slot.

9. The venturi injector of claim 4, wherein the latch includes a spring and wherein the spring engages the latch body such that the latch positively retains the nose portion when the nose portion resides within the port opening and wherein the spring directs the latch out of the slot when the nose portion is not within the port housing.

10. A chemical delivery system, comprising:
a multi-port manifold including an inlet port, a diluent supply line and a plurality of outlet ports, wherein a diluent stream enters the inlet port and is individually distributed to each outlet port through the diluent supply line;
a plurality of latch assemblies, each latch assembly having a latch and a latch body, wherein each latch body is operably coupled to a corresponding outlet port; and
a plurality of venturi injectors, each venturi injector including a venturi mixing assembly having a quick-connect nose portion, wherein the quick-connect nose portion is inserted through an engagement opening in the latch body such that the quick-connect nose portion is fluidly connected to the corresponding outlet port and wherein the latch retains the connection of the venturi injector to the multi-port manifold.

11. The chemical delivery system of claim 10, wherein the latch includes one or more latch projections, and wherein the quick-connect nose portion includes one or more nose projections, wherein the latch projections and nose projections define a keyway shape that allow insertion of the quick-connect nose portion thorough the engagement opening.

12. The chemical delivery system of claim 11, wherein two or more of the corresponding outlet ports, latch assemblies and venturi injectors have a shared exterior color, where said shared exterior color is viewable so as to provide additional confirmation of compatibility.

13. The chemical delivery system of claim 11, wherein each venturi injector includes a valve assembly for selectively controlling flow of the diluent stream through each outlet port.
